(19) United States
(12) Patent Application Publication
(10) Pub. No.: US 2015/0068369 A1
(43) Pub. Date: Mar. 12, 2015

(54) LUG WRENCH ASSISTANT DEVICE

(71) Applicant: Joy Taylor, Eureka, MT (US)

(72) Inventor: Joy Taylor, Eureka, MT (US)

(21) Appl. No.: 14/022,498

(22) Filed: Sep. 10, 2013

(51) Int. Cl. B60B 29/00

(52) U.S. Cl. CPC B60B 29/007
USPC 81/462

(57) ABSTRACT

A lug wrench assistance system including: a lug wrench aid, where the lug wrench aid includes a stop at a first end and stop at a second end where the lug wrench aid is capable of engaging onto a four socket lug wrench; and a pedestal, where the pedestal includes a plurality of legs, a stem extending vertically from the legs and a cradle at the top of the stem, where the cradle receives a socket of the lug wrench during use. The lug wrench aid may include channels for engaging the socket lug wrench and the stem may include a plurality of adjustment holes to vertically adjust the height of the cradle. In the preferred embodiment, the legs are telescoping to provide vertical adjustment and each leg includes a foot as a base. Each foot may also include gripping teeth extending out of the bottom.

### BACKGROUND OF THE INVENTION

1. Field of Invention

The present invention relates to a system to assist an individual in operating a lug wrench while changing of a tire.

2. Description of Related Art

Many individuals encounter flat tires associated with the operation of a motor vehicle. Most flat tires must normally be changed in order for the vehicle to operate properly. Individuals usually have a choice to change the tire themselves or to request emergency roadside assistance that provides tire changing services. The changing of the tire can be strenuous on some individuals and many times some individuals are unable to actually change the tire due to the tightness of the lugs that mount the tires onto the wheel axle. During the tire changing process an individual uses a lug wrench that fits over a lug that needs to be loosened and removed to remove the flat tire from the axle. Further the individual needs to replace the flat tire with a spare tire to proceed. The typical lug wrench is a cross-shaped wrench that has sockets at each end of the cross. The sockets engage the lugs and then the individual may turn the lug wrench to loosen and remove the lug. As stated many times the lugs are tough to remove and require substantial strength to loosen and remove the lugs. Consequently it would be advantageous to have a device that could assist an individual in the removal of lugs from a tire that is mounted.

### SUMMARY OF THE INVENTION

The present invention relates to a lug wrench assistance system comprising: a lug wrench aid, where the lug wrench aid includes a stop at a first end and stop at a second end where the lug wrench aid is capable of engaging onto a four socket lug wrench; and a pedestal, where the pedestal includes a plurality of legs, a stem extending vertically from the legs and a cradle at the top of the stem, where the cradle receives a socket of the lug wrench during use.

The lug wrench aid may include channels for engaging the socket lug wrench and the stem may include a plurality of adjustment holes to vertically adjust the height of the cradle. In the preferred embodiment, the legs are telescoping to provide vertical adjustment and each leg includes a foot as a base. Each foot may also include gripping teeth extending out of the bottom.

### BRIEF DESCRIPTION OF DRAWINGS

FIG. 1 depicts an engagement of a lug wrench aid onto a lug wrench in accordance with the present invention.

FIG. 2 depicts a reverse view of the lug wrench aid attached to the lug wrench.

FIG. 3 depicts a pedestal that is used in conjunction with the lug wrench aid in accordance with the present invention.

FIG. 4 depicts an alternative lug wrench aid that is used in conjunction with the present invention.

FIG. 5 depicts use of the lug wrench aid engaged with a pedestal and a tire.

### DETAILED DESCRIPTION

The present invention relates to lug wrench assistance system that utilizes a lug wrench aid that fits over a portion of the lug wrench and a pedestal that is used to mount the lug wrench during the removal of lugs from a tire. The lug wrench aid allows individuals to gain more leverage over the lug wrench and further to mount the lug wrench on the pedestal to provide for an even and consistent distribution of force on the lug for the removal of a tire.

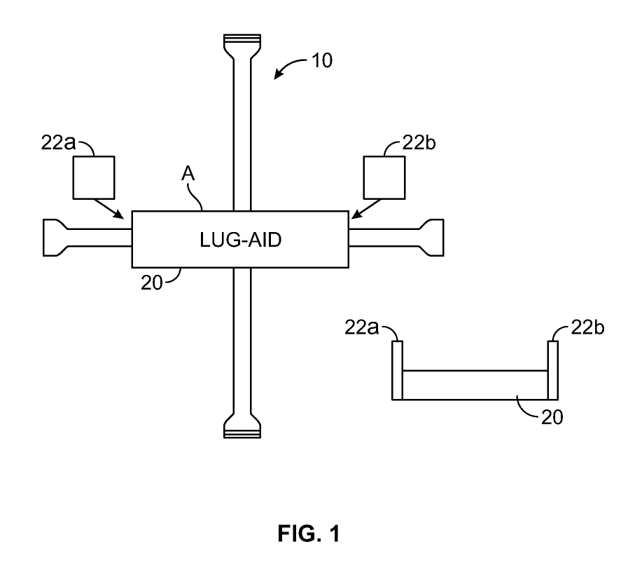

In reference to FIG. 1, a lug wrench aid 20 is depicted attached to a lug wrench 10. The lug wrench aid 20 fits over a portion of the lug wrench 10 to provide a support means that allows an individual to use better leverage and actually allows the individual to lean into the lug wrench to provide sufficient force for the removal of a lug. The lug wrench aid 20 includes stops 22a, 22b at each end of the lug wrench aid 20. The stops 22a, 22b are shown at each end of the lug wrench aid in FIG. 1. These stops 22a, 22b allow for the insertion of fittings of the lug wrench aid onto the lug wrench 10. The lug wrench 10 is a typical lug wrench that has four sockets at each end of a cross-configured wrench.

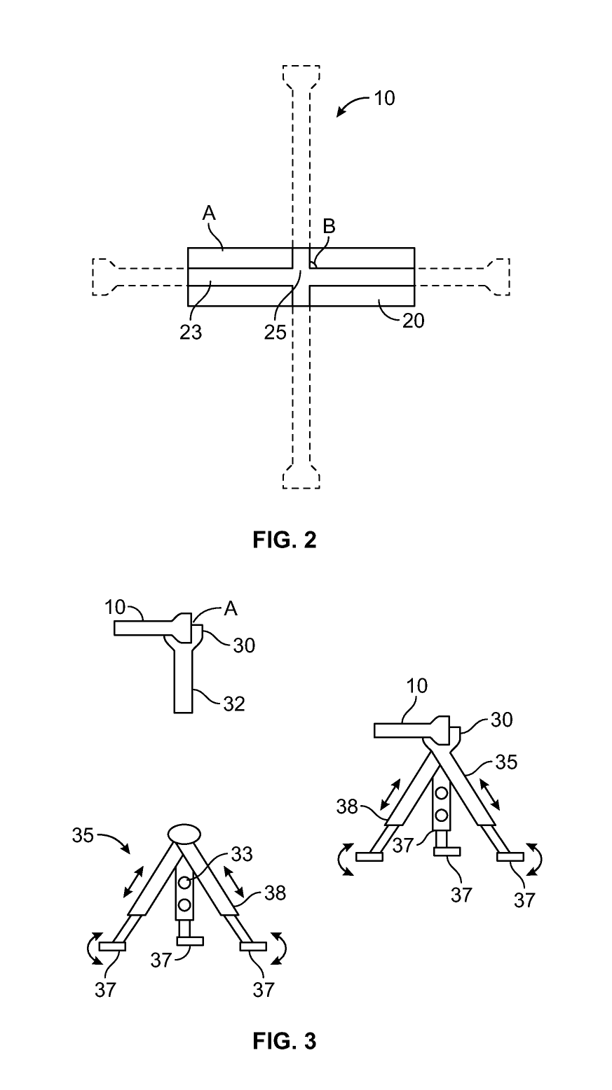

A reverse view of the lug wrench aid 20 is shown at FIG. 2. The lug wrench aid 20 includes a first channel 23 that runs along the length of the lug wrench aid 20. Channel 25 is perpendicular to the channel 23 and vertically is across the lug wrench aid 20. The channel 23 and channel 25 creates a cross opening and engages onto the lug wrench 10.

In reference to FIG. 3 a pedestal 35 is depicted. The pedestal 35 includes a cradle 30. The cradle 30 engages a socket of the lug wrench 10 during use. Below the cradle 30 is a stem 32 that engages a grouping of telescoping legs 38 as shown. Legs 38 and stem 32 create the pedestal 35 for placement of the lug wrench during use. Each leg 38 is adjustable vertically and may be adjusted to fit over a surface to provide a stable mounting piece for the lug wrench. Each leg 38 includes a foot 37 as shown. Also shown in FIG. 3 is the engagement of the wrench 10 onto the cradle 30 depicting the movement of the telescoping legs 38.

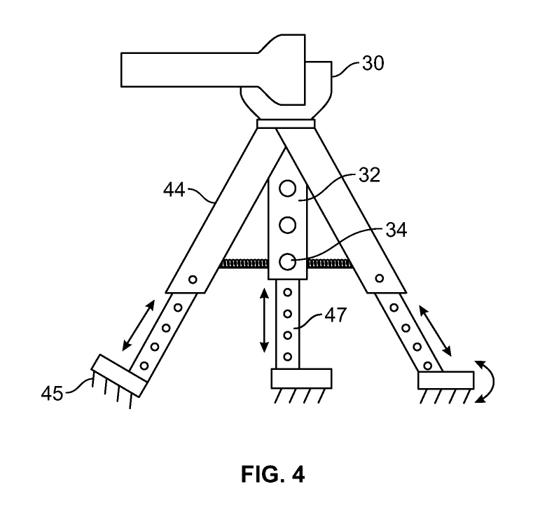

An alternative embodiment is depicted in FIG. 4. The embodiment of FIG. 4 includes the cradle 30 and stem 32 engaged onto a grouping of telescoping legs 44. Each leg 44 has a series of holes 48 along the length of the legs 44 that allow for the adjustment of each leg 44 individually. Each foot 45 shown in FIG. 4 includes gripping teeth that extend out of the bottom surface of each foot. These gripping teeth provide for firm grip onto the surface where the pedestal is placed. The pedestal further includes the cradle 30 at the top of the stem 32 with a series of holes 34 along the stem.

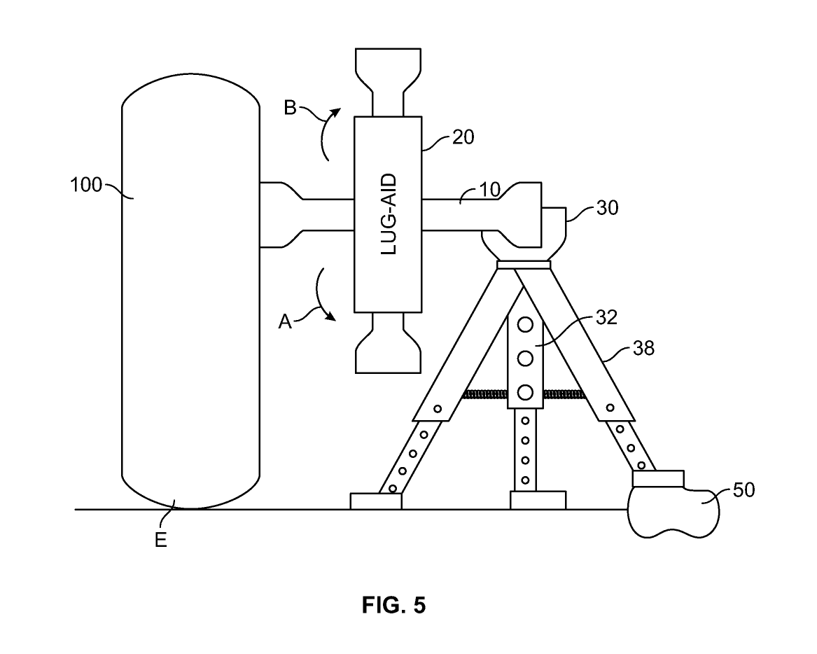

During use the lug wrench aid 20 is engaged onto a lug wrench 10 as shown in FIG. 5. One socket of the lug wrench 10 is engaged into a lug of a tire 100. The lug wrench 10 is then placed on the cradle 30 where the opposite socket is engaged onto the cradle 30. Once mounted on this cradle 30 a person may easily apply the necessary force to the lug wrench in order to loosen or tighten the lug onto the wheel. Further shown in FIG. 5 is a rock 50. The rock 50 merely demonstrates the ability to adjust the telescoping legs 38 at the desired length to accommodate an uneven surface. The instant invention has been shown and described in what it considers to be the most practical and preferred embodiments. It is recognized, however, that departures may be made there from within the scope of the invention and that obvious modifications will occur to a person skilled in the art.

What is claimed is:

1. A lug wrench assistance system comprising:
a. a lug wrench aid, where the lug wrench aid includes a stop at a first end and stop at a second end, where the lug wrench aid is capable of engaging onto a four socket lug wrench; and
b. a pedestal, where the pedestal includes a plurality of legs, a stem extending vertically from the legs and a cradle at the top of the stem, where the cradle receives a socket of the lug wrench during use.

2. The lug wrench assistance system according to claim 1, where the lug wrench aid includes channels for engaging the socket lug wrench.

3. The lug wrench assistance system according to claim 1, where the stem includes a plurality of adjustment holes to vertically adjust the height of the cradle.

4. The lug wrench assistance system according to claim 1, where the plurality of legs are telescoping to provide vertical adjustment.

5. The lug wrench assistance system according to claim 1, where each legs includes a foot as a base.

6. The lug wrench assistance system according to claim 5, where each foot includes gripping teeth.
